(19) United States
(12) Patent Application Publication
(10) Pub. No.: US 2016/0180024 A1
(43) Pub. Date: Jun. 23, 2016

(54) SYSTEM AND METHOD FOR PERSONALIZING A THREE-DIMENSIIONAL MEDICAL/HEALTH RECORD

(71) Applicant: Durgada V Basavaraj, Richmond, VA (US)

(72) Inventor: Durgada V Basavaraj, Richmond, VA (US)

(21) Appl. No.: 14/580,130

(22) Filed: Dec. 22, 2014

(51) Int. Cl. G06F 19/00

(52) U.S. Cl. CPC G06F 19/322; G06F 19/321

(57) ABSTRACT

The present invention provides a system and method for personalizing a three dimensional health record. Accordingly, a system for personalizing a three dimensional medical record includes a handheld touch screen device and a cloud based server. The handheld touch screen device comprises a display, a camera, a processor, stored three dimensional anatomical graphic templates, a health care provider engine and a patient engine. A method for personalizing a three dimensional health care record comprising: entering patient identification information, documenting symptoms and signs for multiple or single part of the body, updating information obtained during patient visit, morphing multiple or single part results in to a final personalized pictorial health record, personalizing three dimensional images to be added serially over the prior visit documentation results in time as the fourth dimensions in documentation of health record and providing security verification to update medical information.

### FIELD OF INVENTION

The embodiments herein generally relate to the field of medical/health records. More specifically, the embodiments described herein relate to a system and method for personalizing a three dimensional medical/health record. Particularly, the embodiments described herein relate to a system and method for personalizing a three dimensional medical/health record for improving access to medical records and developing a good quality of health care at reduced cost.

### BACKGROUND OF THE INVENTION

Current emphasis on Electronic medical (Health) records is primarily text based and because of this format, it is difficult for health care providers to search for relevant information. Moreover, patients and their family also have difficulty in interpreting text based information which can leads to misunderstanding and poor participation. The diagnostic imaging although are in visual and auditory format, is stored in report form in the EMR in text format which at a later time can be deemed misinterpreted. Surgical procedure is currently transcribed at a time days, weeks and months after the procedure (not real time) and has a tendency to be unreliable. Moreover, the recordings will be voluminous, since the requirement to be in text format starting from anesthesia to recovery room. The critical information necessary to review at a later time is not only time consuming, but also prone to be inaccurate and unreliable because the information was not created in real time.

Patients need to be educated about their condition for encouraging participation in their care to better decision making, understanding proper medication intake as well as maintaining their health. With the current emphasis on electronic medical/health record in text format, education is at best difficult and time consuming, and the complexity of it limits recall necessary details.

When a diagnostic imaging is performed, even if the imaging is available, the interpretation is in text format, and patients can have difficulty in interpreting and correlating to their symptoms.

Anatomical graphic modeling is available for education purpose of medical students, surgical students and pharmaceutical research. But, integration with Electronic medical/health record in a pictorial personalized electronic health record format is not available.

Therefore, there is a need in the art to develop a system and method for personalizing a three dimensional health care record to overcome the problem associated with the prior art. Further, there is a need for a system and method for improving access to medical records and helps in taking decision for patients and health care providers with time constraints.

### SUMMARY

In view of the foregoing, an embodiment herein provides a system and method for personalizing a three dimensional health care record. A system for personalizing a three dimensional health care record includes a handheld touch screen device and a cloud based server. The handheld touch screen device comprises a display, a camera, a processor, stored three dimensional anatomical graphic templates, a health care provider engine and a patient engine.

According to an embodiment, a health care provider can enter patient identification information. Here, the health care provider is prompted to choose the sex of the patient and then the three dimensional anatomic model can be opened. If the patient encounters any systemic disorders such as diabetes, hypertension, smoking or alcoholism, which can be electronically filled as color background of the anatomic template. It can also be changed with gradient of different colors or different density of colored pixels for different diseases.

In an embodiment, a location of mild severity indication, moderate severity indication and high severity indication can be marked with different intensity of colored pixels. In the anatomic template, a sound and an image can also be embedded in to the three dimensional anatomical image templates. Morphing sounds and images in to the template gives more data about particular patient visit documentation.

According to an embodiment, the health care provider can be prompted to choose particular part of the body for physician documentation of patient evaluation. Once the particular part of the body is selected, then most common symptoms appear in the subsection. After marking/mapping in to the respective subsection of the particular part of the body in the three dimensional anatomical image templates, the health care provider can upload the image and/or sound to embed in to the particular part of the three dimensional anatomic template. Once, the particular part of the body is completed, and then the next part of the body can be selected. Text entry can also be recorded in that particular part of the three dimensional anatomical body in the sub section.

A method for personalizing a three dimensional medical/health care record comprising: entering patient identification information in a three dimensional anatomic template, documenting physician documentation of patient evaluation of multiple or single part of the body, updating patient visit information regarding multiple or single part of the body, morphing multiple or single part (organ) documentation results in to a final personalized pictorial health record, personalizing subsequent visit documentation into three dimensional images to be added serially over the prior visit documentation results in time as the fourth dimensions in documentation of health record.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The detailed description is set forth with reference to the accompanying figures. In the figures the use of the same reference numbers in different figures indicates similar or identical items.

FIG. 1 illustrates a three dimensional anatomical image template pointing out a location of the severity of a disease, according to an embodiment therein;

FIG. 2 illustrates a three dimensional anatomical image template with morphing sounds, according to an embodiment therein;

FIG. 3 illustrates a three dimensional anatomical image template with morphing images, according to an embodiment therein;

FIG. 4 illustrates a system for personalizing a three dimensional health care record, according to an embodiment therein;

FIG. 5 illustrates a health care provider module in the system for personalizing a three dimensional health care record, according to an embodiment therein;

FIG. 6 illustrates a patient module in the system for personalizing a three dimensional health care record, according to an embodiment therein; and

FIG. 7 illustrates a flowchart for a method for personalizing a three dimensional health care record, according to an embodiment therein;

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

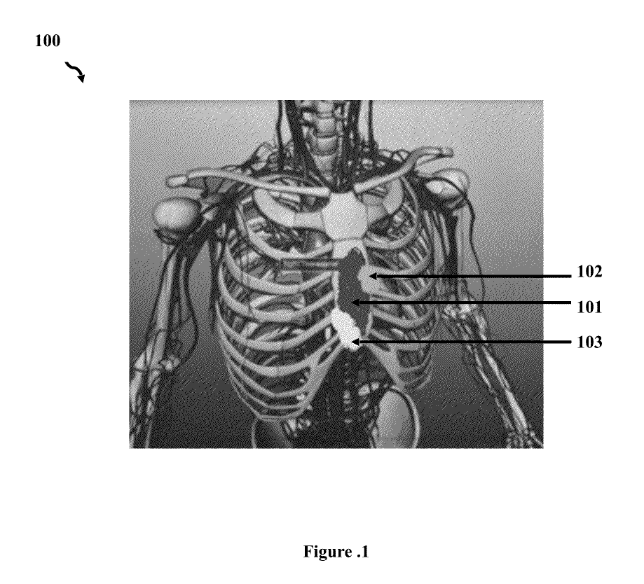

As mentioned above, there remains a need for a system and method for personalizing a three dimensional digital pictorial medical/health record. The embodiments herein achieve this by providing a system and method which improves access for medical records and supports in taking decision for patient and particularly to health care providers with time constraints. Referring now to drawings, and more particularly to FIGS. 1 through 7, where similar reference characters denote corresponding features consistently throughout the figures, there are shown preferred embodiments.

According to an embodiment, FIG. 1 illustrates a three dimensional anatomical image template 100 pointing out a location of the symptom like pain. Initially, a health care provider can enter patient identification information. Here, the health care provider is prompted to choose the sex of the patient and then the three dimensional anatomic model can be opened.

In an embodiment, if the patient encounters any systemic disorders such as diabetes, hypertension, smoking or alcoholism that can be electronically filled and can be changed with gradient of different colors or different density of colored pixels for disease specific identification. In the FIG. 1, 101 can specify a location of symptom pain. In a similar way, the health care provider can specify a location of observed swelling 102 and a location of sign of tenderness 103.

According to an embodiment, the health care provider can be prompted to choose particular part of the body for visit documentation. Once the particular part of the body is selected, then most common examination results like normal/abnormal can be programmed to appear in the subsection. After entering in to the respective subsection of the particular part of the body in a three dimensional anatomical image template can be opened.

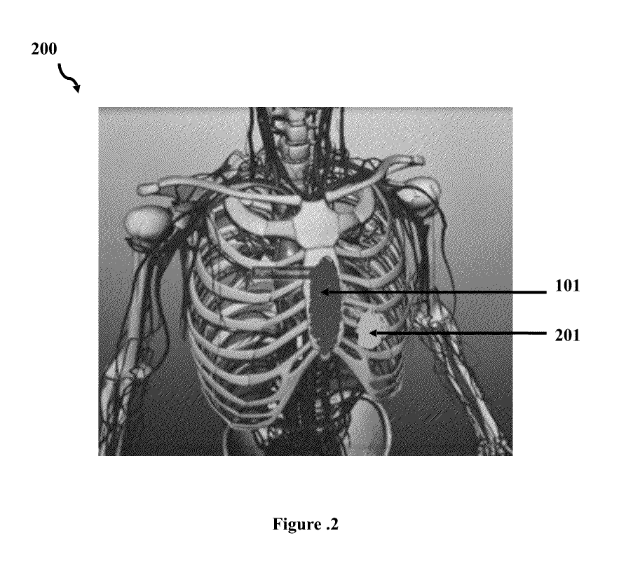

According to an embodiment, FIG. 2 illustrates a three dimensional anatomical image template with morphing sounds. Morphing sounds 201 in to the template gives more data about a particular disease. The health care provider can upload the sound 201 to imbed in to the particular part of the three dimensional anatomic template. Once, the particular part of the body is completed, and then the next part of the body can be selected. Text entry can also be recorded at the level of selecting specifically selecting particular part of the body in the sub section.

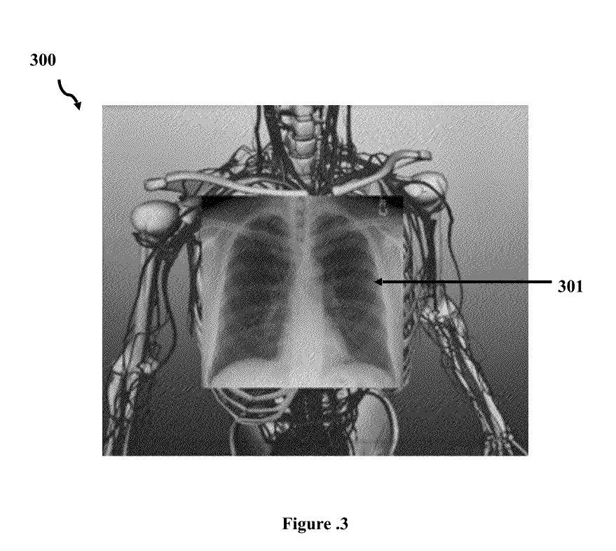

FIG. 3 illustrates a three dimensional anatomical image template with morphing images, according to an embodiment. Morphing images 301 in to the template provides more data about a particular disease. The images can be a scan or x-ray or other images.

In an example embodiment, “Swelling”, “pain” and “numb” are multiple symptoms. When “swelling” is selected, the screen may prompt to take a picture and the picture of that part to embed and morph that anatomical part from a model to a personalized organ. If there is identifiable objective abnormality like swelling it is better to embed/morph that part of the body picture before painting other symptoms during examination. When pain is selected the screen may prompt and a brush appears to paint the location of the pain, then color coded to severity of pain. Selecting symptom of “numb” will give the option of painting gradients to the location of numbness. Duration of symptom is identified with the day or week or month the symptom started. The window appears next to the part to date the onset of symptom. Other information of symptoms like character, continuous or intermittent can be entered in text format and may be recorded permanently in text format next to the anatomic template.

In an example embodiment, after the screen of “symptoms” are completed and saved, next screen twin three dimensional anatomic model for physical abnormality to be updated on that part of the Anatomical part. Like tenderness can be mapped over the body color coded to the severity. Abnormal heart sounds are recorded real time in recordable stethoscope and the audio is morphed over the location of the abnormal sounds. Carotid sounds can be recorded and embedded over the carotids. Normal examination of parts and systems can be documented by clicking mouse hovered over that part and right clicking it will check mark next to the sub region of the system and the body part as part for storing as permanent record implying normal findings as documentation for that visit.

In an example embodiment, updating the diagnostic images like Radiological X-ray of chest and if it is three dimensional may morph the bone structures in the three dimensional anatomical body into actual radiological images, like wise if the dynamic ultrasound of the heart can morph the dynamic image of the heart into actual scanned image. If three dimensional anatomical template cannot be morphed, then the diagnostic test is embedded. Clicking on it will bring out the text of the interpretation or the option to enter text information screen either by typing or through dictating software.

In an example embodiment, multiple or single systems and parts are evaluated, and diagnostic test are morphed, a final personalized pictorial medical (health) record is the permanent record for that patient visit. This final image can be carried by the patient in his/her mobile device and if any emergency situation, medical information in the form of personalized pictorial Medical (health) record is readily available for first responders. This personalized three dimensional image in due course will be added fourth dimension, when subsequent visits are documented and superimposed over prior image.

According to an embodiment, the patient can view the three dimensional health records for a time period from initial stage and up to recovery. In each stage, the three dimensional health care record can be updated and sounds and images can be uploaded with respect to the health care record of the patient. Days apart, serial three dimensional images are superimposed and will result in a four dimensional personalized pictorial health record. This makes easy for the health care provider and the patient to view the health care record with upgraded information in fourth dimension.

In an example embodiment, if a person has severe back pain and undergo MRI of the spine and a diagnosis of Disc herniation was made, but no surgery was performed, while symptom improves with treatment. After a year if patient have similar problem, and repeat evaluation with MRI after embedding or morphing the spinal canal, the reviewer will have the option of super imposing two images which are 1 year apart to conclusively determine if the disc has worsened and surgery will be appropriate treatment. Ultimately the personalized health record “Grows” with the patient and gradually morphed and aged which will help to judge if any abnormality is normal aging or a significant abnormality to undergo invasive procedures.

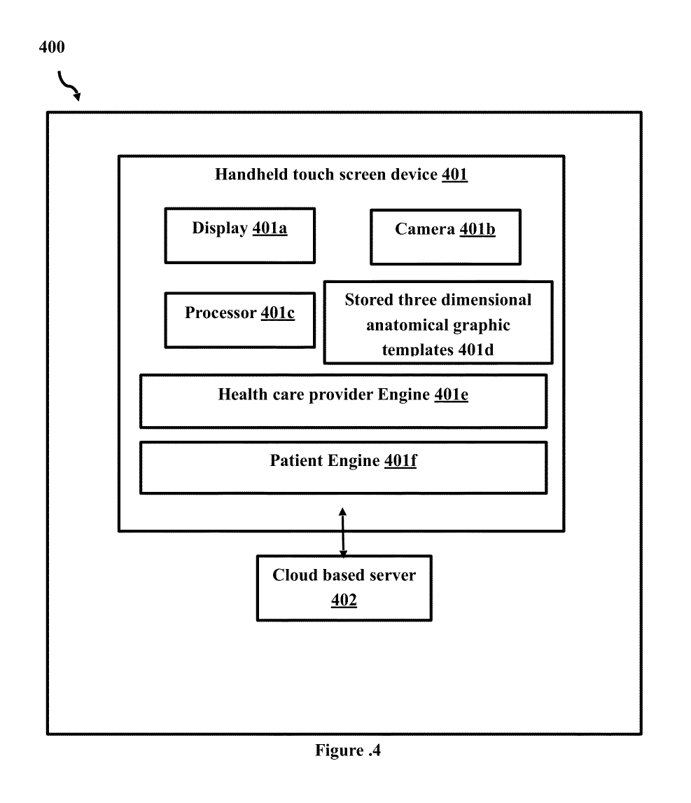

According to an embodiment, FIG. 4 illustrates a system 400 for personalizing a three dimensional medical/health record. In an embodiment, the system for personalizing a three dimensional medical/health record includes a handheld touch screen device 401 and a cloud based server 402. The handheld touch screen device comprises a display 401a, a camera 401b, a processor 401c, stored three dimensional anatomical graphic templates 401d, a health care provider engine 401e and a patient engine 401f.

According to an embodiment, the display 401a can be used to access three dimensional anatomic image of a personalized anatomy. The display of the image can be either in two dimensional or three dimensional digital images. Displaying of the personalized image can be used for the purpose of documenting patient visit evaluation into a medical/health record.

According to an embodiment, the camera 401b can be used to capture real time images of the patients and later, those images can be uploaded to morph that part of the anatomy in the three dimensional anatomic image templates.

According to an embodiment, the processor 401c includes a logic circuitry that responds to and processes the instruction given by the user (or health care provider). The processor can be designed to execute all the necessary instruction and the respective instruction can be performed to morph the three dimensional anatomic template.

According to an embodiment, the stored three dimensional anatomical graphic templates 401d include templates of various parts of the body. The templates can be dynamically modified with gradient of different colors or different density of colored pixels to identify various affected parts of the body.

According to an embodiment, the health care provider engine 401e can include necessary modules for performing the necessary operations which includes interface module and other required modules.

According to an embodiment, the patient engine 401f can include necessary modules for performing the necessary operations which includes authentication module and other required modules.

According to an embodiment, the cloud based server 402 can store three dimensional images as a template and it is capable of accepting request from thee client and gives responses accordingly.

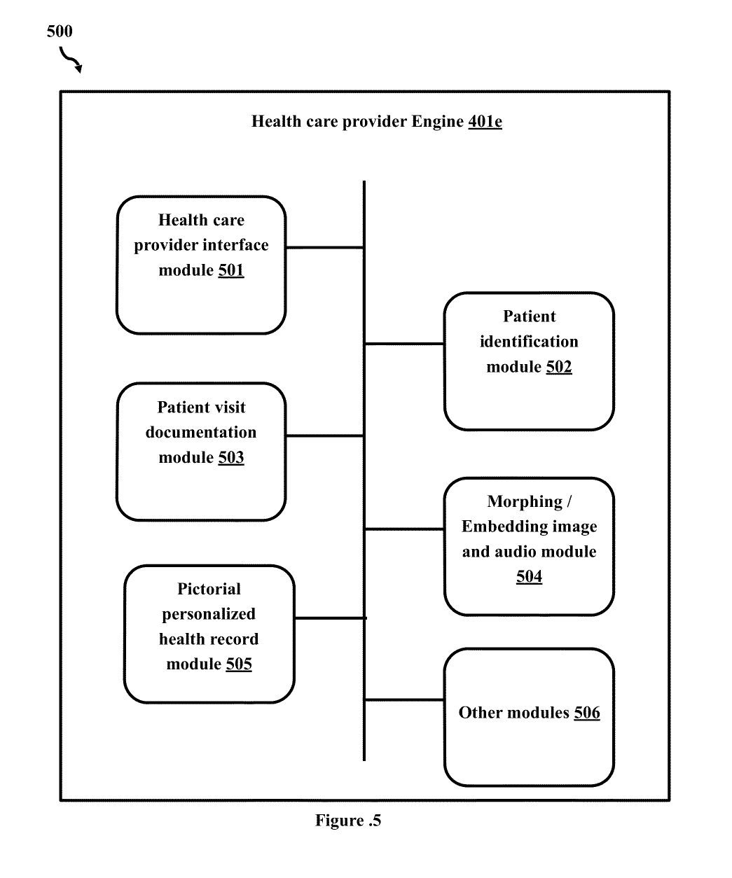

FIG. 5 illustrates a health care provider module in the system for personalizing a three dimensional health care record, according to an embodiment. The health care provider module 401e includes health care provider interface module 501, patient identification module 502, patient visit documentation module 503, morphing/embedding image and audio module 504, pictorial personalized health record module 505 and other modules 506.

According to an embodiment, health care provider interface module 501 forms as an interface between the health care provider and the patient. The health care provider interface module can act as a shared boundary across the health care provider and the patient for exchanging information.

In an embodiment, the patient identification module 502 includes all the required patient information which can be collected by the health care provider. The patient information module includes primary information of patients such as all the basic information of the patients and the symptoms of diseases and other information.

According to an embodiment, the patient visit documentation module 503 used by the health care provider utilizes the three dimensional anatomic image template which clearly states about the signs and symptoms of the patients. Based on the information provided in the personalized three dimensional anatomic image document of the particular patient, the health care provider can evaluate, diagnose and treat the patients.

According to an embodiment, the image obtained from provider module to morph the anatomical template and audio module 504 supports to upload the concerned images and sounds to be inserted in to the three dimensional anatomic image templates. Further, the images and sounds morphed or morphing in to the three dimensional anatomic image template information can be updated.

In an embodiment, the pictorial personalized health care module 505 is a collection of personalized content of three dimensional medical records of patients. This medical record is easily accessible and provides all the necessary information with respect to the patient evaluations and thereby improves quality of medical records.

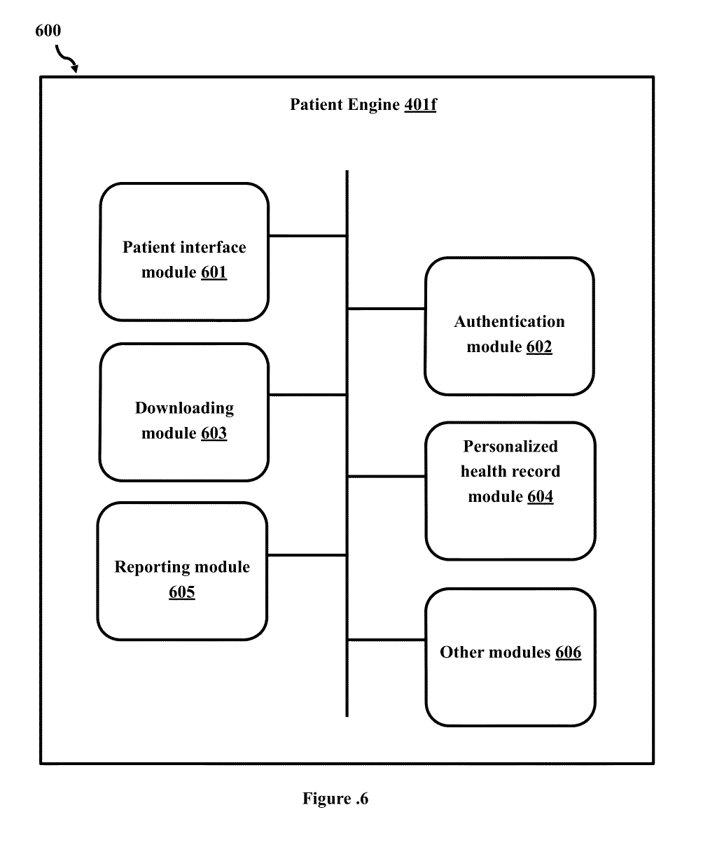

FIG. 6 illustrates a patient module in the system for personalizing a three dimensional health care record, according to an embodiment. The patient module 401f includes patient interface module 601, authentication module 602, downloading module 603, personalized health record module 604, reporting module 605 and other modules 606.

According to an embodiment, the patient interface module 601 forms as an interface between the patient and the health care provider. The patient interface module can act as a shared boundary across the health care provider and the patient for exchanging information.

According to an embodiment, the authentication module 602 provides security to the three dimensional anatomic template which can be protected in the form of biometric and barcode verification.

According to an embodiment, the downloading module 603 can supports for downloading the images and sounds that and all necessary for morphing in to the three dimensional anatomic templates. Further, the downloading module supports for downloads and keeps necessary images and sounds to be saved in to mobile device.

According to an embodiment, the pictorial personalized health care module 604 is a collection of personalized content of three dimensional medical records of patients. This medical record is easily accessible and provides all the necessary information with respect to the patient disease and thereby improves access to the medical records.

In an embodiment, the reporting module 605 can be used to give feedback about the three dimensional personalized medical records and may also be utilized to report the problems associated with the three dimensional personalized medical records.

In an example embodiment, a system and a method for personalizing a three dimensional health record image based with very minimal text based information demanding less time spent and is more accurate. The system and method for personalizing a three dimensional health record facilitates can be easy for discussing with the patient. When patients are full participant in decision making based on accurate and understandable medium (pictorial health record). More over all this is easily available to the patient to be downloaded into their mobile device which is secured with biometric validation. When patient encounter's an emergency medical situation, most of the medical information is available to the first responders.

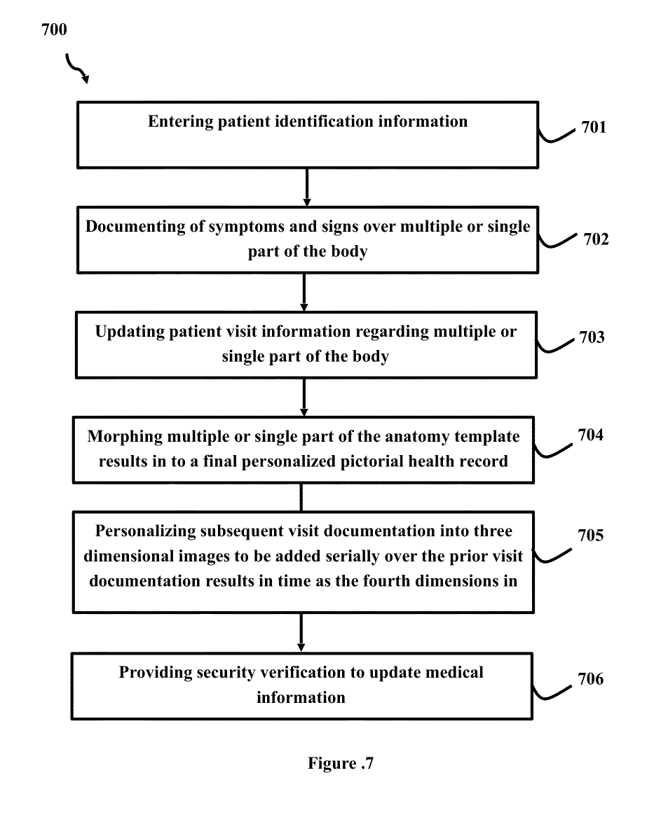

FIG. 7 illustrates a flowchart for a method for personalizing a three dimensional health record, according to an embodiment. The method for personalizing a three dimensional health record includes entering patient identification information 701, documenting of symptoms and signs over multiple or single part of the body 702, updating patient visit information regarding multiple or single part of the body 703, morphing multiple or single part results in to a final personalized pictorial health record 704, personalizing subsequent visit documentation into three dimensional images to be added serially over the prior visit documentation results in time as the fourth dimensions in documentation of health record 705 and providing security verification to update medical information 706.

At block 701, entering patient identification information can be performed. The patient information includes all the basic information of the patients. The health care provider can enter and confirm all the patient identification information which includes all the basic information of the patient.

At block 702, diagnosing multiple or single part of the body can be performed. In this block, the health care provider can diagnose a particular part of the body and can enter all the specific details related to the particular part of the body. Initially, subsections related to the particular part of the body can be opened and in that the health care provider can select the necessary parts and then can document the symptoms and signs.

At block 703, updating more information regarding multiple or single part of the body can be performed. More information can be updated with respect to the particular multiple or single part of the body. Updated medical information can include images or sounds.

At block 704, morphing multiple or single part or organ results in to a final personalized pictorial health record. Here, updated medical information can include images or sounds.

At block 705, personalizing three dimensional images to be added in four dimensions. Then the three dimensional images can be converted in to four dimensions. This implies that the more updated information with the combination of symptoms, sounds and images can be present in personalized four dimensions.

At block 706, providing security verification to update medical information. Biometric and barcode security information can be provided in to mobile device in order to update the medical information.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A system for personalizing a three dimensional health care record comprising:
a handheld touch screen device includes a display, a camera, a processor, stored three dimensional anatomical graphic templates, a health care provider engine and a patient engine; and
a cloud based server for storing a three dimensional image.

2. The system of claim 1, wherein said health care provider engine includes health care provider interface module, patient identification module, patient visit documentation module, morphing or embedding image and audio module , pictorial personalized health record module and other modules.

3. The system of claim 1, wherein said patient engine includes patient interface module, authentication module, downloading module, personalized health record module, reporting module and other modules.

4. The system of claim 1, wherein said cloud based server store three dimensional image template for personalizing said image in to a three dimensional health care record.

5. The system of claim 1, wherein said system improves access to medical records and facilitates participation by the patients while accommodating time constraints of the health care providers.

6. A method for personalizing a three dimensional medical (health) care record comprising:
entering patient identification information in a three dimensional anatomic template, documenting patient's normal as well as abnormal findings in the form of mapping on multiple or single part of the body, updating patient visit information regarding multiple or single part of the body, morphing multiple or single part of the three dimensional anatomic template results in to a final personalized pictorial health record, personalizing subsequent visit documentation as three dimensional images to be added serially over the prior visit documentation results in time as the fourth dimensions in documentation of health record and providing security verification to update medical information.

7. The method of claim 6, wherein a health care provider enters patient identification information.

8. The method of claim 6, wherein a location of mild indication, moderate indication and high indication of severity can be marked with different intensity of colored pixels at the time of diagnosing parts of the body.

9. The method of claim 6, wherein said images to morph anatomical template to personalize.

10. The method of claim 6, wherein said morphing the three dimensional anatomic template with sounds and images gives visually understand particular patient visit documentation while text entry can also be recorded at the level of selecting specifically selecting particular part of the body.
